(19) United States
(12) Patent Application Publication
(10) Pub. No.: US 2007/0132551 A1
(43) Pub. Date: Jun. 14, 2007

(54) Operation and control of mechanical devices using shape memory materials and biometric information

(75) Inventors: Forrest S. Mozer, Berkeley, CA (US); Todd F. Mozer, Los Altos Hills, CA (US); Jeffrey D. Rogers, Lake Oswego, OR (US); Tetsuro Hirouji, Milpitas, CA (US); Alec M. Plauche, Berkeley, CA (US); Robert T. Duck, San Francisco, CA (US)

Correspondence Address: Fountainhead Law Group, PC;Suite 509, 900 Lafayette St., Santa Clara, CA, 95050, US

(73) Assignee: Sensory, Inc., a California Corporation, Sunnyvale, CA (US)

(21) Appl. No.: 11/580,269

(22) Filed: Oct. 11, 2006

Related U.S. Application Data
(60) Provisional application No. 60/749,537, filed on Dec. 12, 2005.

(51) Int. Cl. G05B 19/00

(52) U.S. Cl. 340/5.52; 382/115; 704/270; 70/277

(57) ABSTRACT

In one embodiment the present invention includes a biometric information recognizer and a shape memory material. The biometric information recognizer recognizes biometric information (such as speech) and signals the shape memory material with a current. The current causes the shape memory material to change shape, thereby reconfiguring a mechanical device. Such mechanical device may include a lock. In such manner, the lock may be isolated from external tampering (such as physical stressing) yet receptive to biometric information for controlling access.

### CROSS REFERENCE TO RELATED APPLICATIONS

The present application claims priority to U.S. Provisional Application No. 60/749,537, titled “Operation and Control of Mechanical Devices using Shape Memory Materials and Biometric Information”, filed Dec. 12, 2005.

### BACKGROUND

The present invention relates to control of mechanical devices, and in particular, to the operation and control of mechanical devices using shape memory materials and biometric information.

Shape memory materials are electromechanically active materials having the property that they change their shape and/or length when a voltage is applied and they are restored to their original shape or length after the voltage is removed. This class of materials was discovered in the 1950s (see K. Otsuka and C. M. Wayman, “Shape Memory Materials”, Cambridge University Press, Cambridge, England, 1998, ISBN 0-521-44487X). Their properties are described in references such as U.S. Pat. No. 6,574,958; a Technical Information Pamphlet from the Dynalloy Corporation titled “Technical Characteristics of Flexinol Actuator Wires”; and the book “Muscle Wires Project Book” by Roger Gilbertson. One example of a shape memory material is the material Nitinol. Other examples of shape memory materials include the heliomorphs produced by 1 Limited, which are piezoelectric devices that change their shape when a voltage is applied. Shape memory alloy wires such as Nitinol contract by 3-8% of their length when heated to a temperature less than 100° centigrade.

Shape memory materials may be used in a wide variety of mechanical applications. For example, U.S. Pat. Nos. 5,139,454 and 6,845,965 describe animation activation in a greeting card, panel display, electronic trading card, or the like. The animations may be activated by pushing buttons, opening a card, etc.

Mechanical keys may be used to control access to devices. For example, U.S. Pat. No. 5,564,936 describes a security mechanism for an electronic card that may be activated by application of a key. Similarly, U.S. Pat. Nos. 5,905,446, 5,946,840, and 6,082,153 describe security lock mechanisms for handguns or other devices, all of which may be activated by insertion of a key.

Biometrics is a group of technologies and computerized methods that are able to identify and verify individuals based on physical or behavioral characteristics. The biometric techniques match the patterns of these individuals, in real time, against a database of enrolled records. The main biometric technologies include fingerprint, face, hand geometry, iris, palm, handwriting, voice and skin. Examples of companies that produce biometric solutions are Sensory, Inc., UPEK, Atrua Technologies, UNISYS, Identix, Atmel, and Authentec.

Speech recognition may be used to control the operation of many mechanical devices. For example, the Furby doll from Hasbro moves its eyes and ears in response to recognized phrases. The Radica Password Journal opens a lock on a box when the user speaks the appropriate password. MGA makes a Bratz Safe that performs the same function. MGA makes the Commandobot, which is a robot that moves in response to voice commands. Hasbro makes Scamps, My Playful Pup, which also moves in response to voice commands.

These products and many others suffer problems resulting from their activation by electric motors. Electric motors are relatively costly, which impacts the number of possible applications as well as the retail price and sales volumes of such products. Electric motors are noisy, so it destroys the realism of products such as dolls, pet dogs, etc. Electric motors require relatively large, long duration currents, which can drain batteries at a high rate. Electric motors are relatively large in physical size, which eliminates the possibility of making truly miniature devices. Electric motors involve magnets and lubricants in the motors, which may be incompatible with many applications. Finally, electric motors require a gearing mechanism to convert the motor's rotary motion into a linear motion that may be required to activate many devices.

For example, the Radica Password Journal requires a one cubic inch motor, a one cubic inch gear mechanism that converts the rotary motor output to a linear motion to open a lock, several capacitors and resistors, one or more transistors, a few square inches of plastic, mechanical stops and circuit breakers, etc.

It is desired to reduce the size of mechanical controls for devices. Further, it is desired to activate and control a wider variety of devices using biometrics. In addition, it is desired to improve security of devices by recognizing the owner's password in the owner's voice or other biometric information relevant to a particular user. Additionally, for devices that are secured by a key, the key may be lost or duplicated, in which case it is desired to use biometric information to access the device in place of the key. Finally, it is desired to use shape memory material and biometric information for security or control in order to simplify certain applications, add features to other applications, and provide a higher level of security for still other applications.

Thus, there is a need for improved operation and control of mechanical devices using shape memory materials and biometric information.

### SUMMARY

Embodiments of the present invention improve operation and control of mechanical devices using shape memory materials and biometric information.

In one embodiment, the present invention includes an electro-mechanical system comprising a biometric input device for receiving a biometric input from a user, a biometric recognizer for recognizing the biometric input, the biometric recognizer generating recognition results, a mechanical device, and one or more shape memory elements coupled to the mechanical device and responsive to the recognition results.

In one embodiment, the present invention includes an apparatus for controlling a mechanical device, comprising a biometric information recognizer that processes a biometric input signal, and in accordance therewith, generates a recognition result, and a shape memory material coupled to said biometric information recognizer, wherein said biometric information recognizer triggers a current in said shape memory material if said recognition result indicates that said biometric input signal includes a predetermined criterion, and wherein said shape memory material changes shape in response to said current and reconfigures said mechanical device.

In one embodiment, the biometric information recognizer comprises a speech recognizer, and wherein said biometric input signal comprises a speech input signal.

In one embodiment, the biometric input signal comprises a speech input signal, and wherein said predetermined criterion comprises a predetermined password spoken by a predetermined speaker.

In one embodiment, the present invention further comprises a manual override device that reconfigures said mechanical device when said recognition result does not indicate that said biometric information signal includes said predetermined criterion.

In one embodiment, the biometric input signal comprises one of a fingerprint, a face, a hand geometry configuration, an iris, a handwriting sample, and a skin configuration.

In one embodiment, the biometric information recognizer operates in a low power sleep mode, and wherein said biometric information recognizer changes from said low power sleep mode to a normal operation mode in response to a distinctive audio signal.

In one embodiment, the biometric information recognizer operates in a low power sleep mode, and wherein the biometric information recognizer changes from said low power sleep mode to a normal operation mode in response to one of a whistle and a hand clap.

In one embodiment, the present invention further comprises a push button coupled to said biometric information recognizer, wherein said biometric information recognizer operates in a low power sleep mode, and wherein said biometric information recognizer changes from said low power sleep mode to a normal operation mode in response to operation of said push button.

In one embodiment, the present invention further comprises a sensor that interrupts said current after said mechanical device has been reconfigured.

In one embodiment, the present invention further comprises a mechanical switch that interrupts said current after said mechanical device has been reconfigured.

In one embodiment, the present invention further comprises a mechanical lock that overrides said biometric information recognizer.

In one embodiment, the present invention further comprises a spring, coupled to said shape memory material, wherein said spring operates to reconfigure said mechanical device, and wherein spring forces of said spring are provided by stresses in plastic.

In one embodiment, the mechanical device comprises a lock.

In one embodiment, the mechanical device controls facial features of a doll.

In one embodiment, the mechanical device controls animation of an object.

In one embodiment, the present invention further comprises a mechanical lock, wherein said shape memory material changes shape in response to said current and unlocks said mechanical lock.

In one embodiment, the present invention further comprises a mechanical lock having a lock piston, wherein said shape memory material controls insertion of said lock piston in said mechanical lock, and a container having therein said biometric information recognizer and said shape memory material.

In one embodiment, the present invention further comprises a zipper bag having therein said biometric information recognizer and said shape memory material, and a mechanical lock having a lock piston, wherein said shape memory material controls insertion of said lock piston between zipper handles of said zipper bag.

In one embodiment, the present invention further comprises a chain, and a mechanical lock having a lock piston, wherein said shape memory material controls insertion of said lock piston in said mechanical lock, and wherein said lock piston is inserted through eyelets that are connected to each end of said chain.

In one embodiment, the present invention further comprises an external chain, and a mechanical lock having a lock piston, wherein said shape memory material controls insertion of said lock piston in said mechanical lock, and wherein said external chain is attached to said mechanical lock.

In one embodiment, the present invention further comprises a mechanical lock having a lock piston, wherein said shape memory material controls insertion of said lock piston in said mechanical lock, and a container having therein said biometric information recognizer, said shape memory material, and said mechanical lock, wherein said container isolates said mechanical lock from outside manipulation

In one embodiment, the shape memory material comprises a shape memory alloy.

In one embodiment, the shape memory material comprises a shape memory wire.

In one embodiment, the present invention further comprises an indicator that indicates a state of said apparatus, wherein said state of said apparatus may be one of an idle state, an input acceptance state, and a programming state.

In one embodiment, the present invention further comprises a light-emitting diode that indicates a state of said apparatus, wherein said state of said apparatus may be one of an idle state, an input acceptance state, and a programming state.

In one embodiment, the present invention further comprises a tone generator that indicates a state of said apparatus, wherein said state of said apparatus may be one of an idle state, an input acceptance state, and a programming state.

In one embodiment, the present invention further comprises a method of controlling a mechanical device comprising receiving a biometric input signal, processing said biometric input signal in a biometric information recognizer, and in accordance therewith, generating a recognition result, generating a current in a shape memory material if said recognition result indicates that said biometric input signal includes a predetermined criterion, wherein said shape memory material changes shape in response to said current and reconfigures said mechanical device.

In one embodiment, the biometric information recognizer comprises a speech recognizer, and wherein said biometric input signal comprises a speech input signal.

In one embodiment, the biometric input signal comprises a speech input signal, and wherein said predetermined criterion comprises a predetermined password spoken by a predetermined speaker.

In this manner, the embodiments of the present invention reduce the size of mechanical controls for devices, reduce the noise generated by devices, improve the security of access to devices, and reduce the power consumption of devices.

The following detailed description and accompanying drawings provide a better understanding of the nature and advantages of the present invention.

### BRIEF DESCRIPTION OF THE DRAWINGS

FIG. 1A illustrates a system according to one embodiment of the present invention.

FIG. 1B illustrates the mechanical construction of a lock box that employs a shape memory alloy wire for its activation by a voice password that provides security, according to an embodiment of the present invention.

FIG. 2A is a circuit schematic illustrating the activation of a lock by heating a shape memory alloy wire, according to an embodiment of the present invention.

FIG. 2B is a flow chart showing operation of a system according to an embodiment of the present invention.

FIG. 3 is a simplified diagram of a locking mechanism that illustrates forces and displacements of a shape memory alloy wire and the locking mechanism, according to an embodiment of the present invention.

FIG. 4 is a side view of a zipper used in a locking device according to an embodiment of the present invention.

FIG. 5 is a cut-away view of a zipper locking device as seen from the inside of a suitcase, according to an embodiment of the present invention. This is a 90 degree rotated view of FIG. 4.

FIG. 6 is an engineering drawing of a zipper locking device in a locked configuration, according to an embodiment of the present invention.

FIG. 7 is an engineering drawing of a zipper locking device in an unlocked configuration, according to an embodiment of the present invention.

FIG. 8 is a diagram of a device that moves a rod left or right when an appropriate biometric signal is received, according to an embodiment of the present invention.

FIG. 9 is a schematic of the operation of the electronics associated with the device of FIG. 8, according to an embodiment of the present invention.

### DISCLOSURE OF SPECIFIC EXAMPLES

The present invention relates to control of mechanical devices, and in particular, to the operation and control of mechanical devices using shape memory materials and biometric information.

Described herein are techniques for controlling a shape memory material with biometric signals. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

Embodiments of the present invention use the properties of shape memory materials such as Nitinol to achieve the desired result. However, embodiments of the invention are intended to encompass any shape memory material in any form that is consistent with the concepts of this invention and all such materials are called shape memory materials in this patent application.

Embodiments of the present invention use biometric recognition, such as speech recognition, although it is recognized that such use does not exclude other methods of recognition of an individual via biometric information.

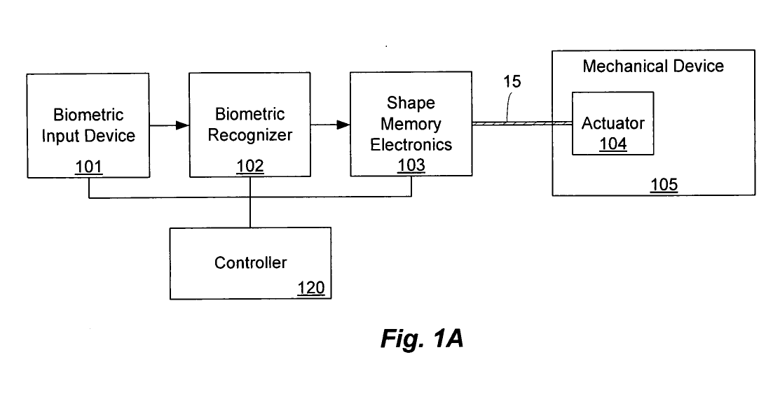

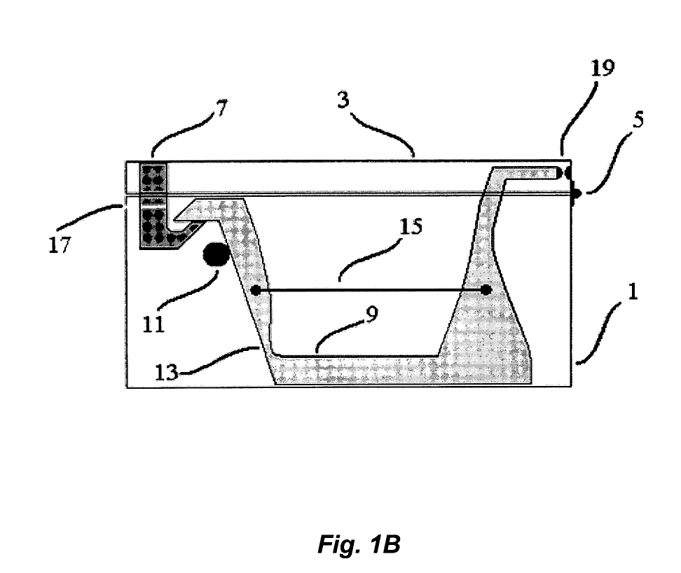

FIG. 1A illustrates a system according to one embodiment of the present invention. In one embodiment, a biometric input device 101 receives a biometric input from a user. The biometric input is provided to a biometric recognizer 102. Biometric recognizer 102 may execute a recognition algorithm on biometric input from the user and generate corresponding results. The results of the recognition may be used to control shape memory electronics 103 that reconfigure a shape memory 15. Shape memory 15 may be coupled to an actuator 104 in a mechanical device 105 for controlling the operation of the mechanical device. Accordingly, different biometric inputs may be used to trigger different mechanical functions or movements using a shape memory that is reconfigured by the electronics. The reconfigured shape memory translates electrical information into any type of mechanical movement through actuator 104. In the following examples, the biometric technology example is speech recognition, and the mechanical system is a locking device. However, other types of biometric technologies may be used to reconfigure one or more shape memories to control the operation of a variety of different mechanical devices. In one embodiment, the present invention may include software the executes algorithms on a controller 120 (i.e., a microprocessor, microcontroller, ASIC, or state machine) for electronically controlling the biometric input device 101, biometric recognizer 102, and shape memory electronics 103.

FIG. 1B illustrates the mechanical construction of a lock box that employs a shape memory alloy wire for its activation by a voice password that provides security, according to an embodiment of the present invention. According to one embodiment, the lock box is a secure box that may be opened by a user saying his or her secret password. This locked box is shown in FIG. 1 to include a main box 1, a lid 3, and a hinge 5 that connects the main box 1 to the lid 3. The lid 3 has a hook 7 attached thereto, and the main box 1 contains a part 9. The hook 7 and the part 9 may be formed from injection molded plastic materials, for example. The part 9 contains a left latching portion and a right switch portion. Left portion, in combination with the hook 7, keeps the lid 3 closed and locked. A shape memory wire 15 has the property that it contracts when heated to pull the left portion of the part 9 to the right and thereby to unlatch the lid 3. The tip of the right portion of the part 9 is a conductor that is part of a mechanical switch 19. The tip of the right portion of the part 9 pushes against a conductor that is connected to the lid 3 and that is the other part of the mechanical switch 19. When the shape memory wire 15 is heated to contract and thereby to free the hook 7, the force exerted on the lid 3 by the right portion of the part 9 causes the lid 3 and the mechanical switch 19 to open. Both the left and right portions of the part 9 are under stress such that they push against their constraints. The right constraint is the lid 3, and the left constraint is a stop 11. Thus, the left and right portions of the part 9 act as if they are spring loaded, because they bend at their thinnest portions, the left-most bending point being located at a pivot point 13 of the part 9.

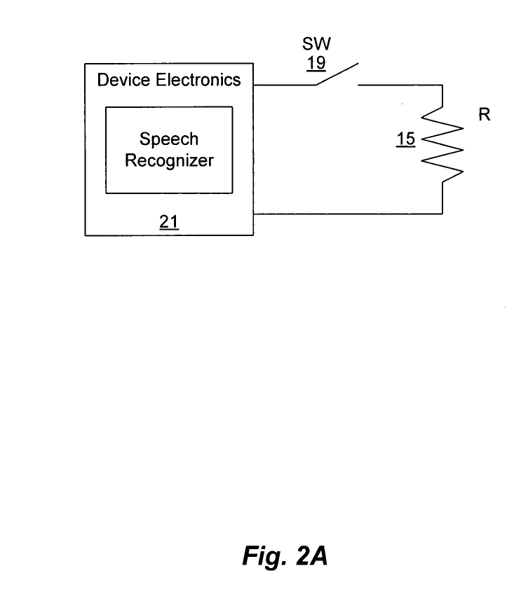

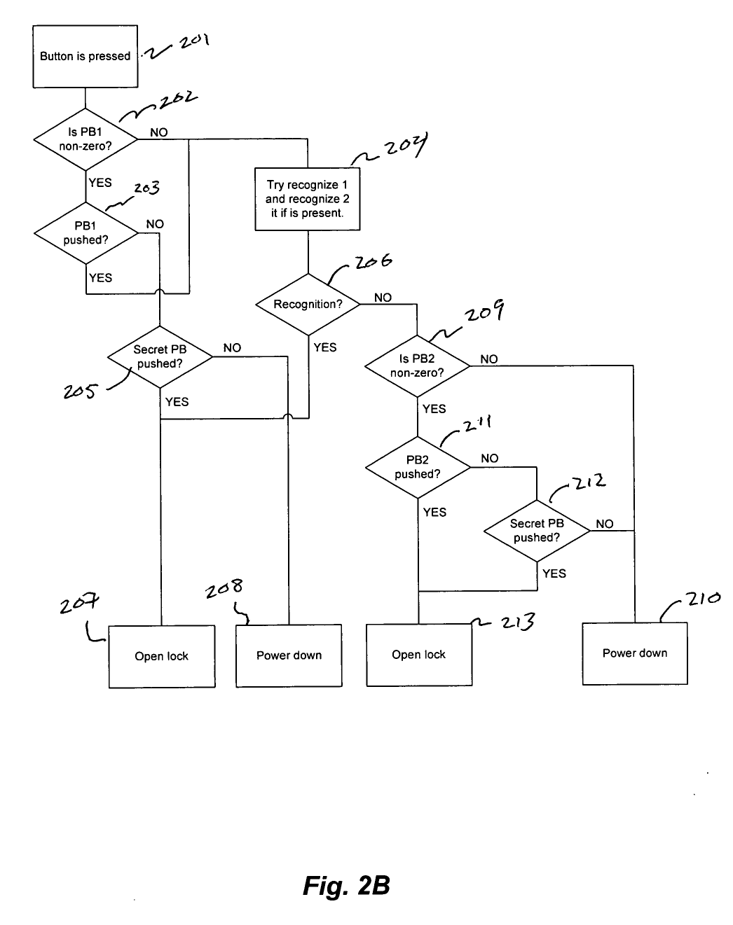

FIG. 2A is a circuit schematic illustrating the activation of a lock by heating a shape memory alloy wire, according to an embodiment of the present invention. FIG. 2A illustrates the electrical connection and a method of operation of the lock box shown in FIG. 1B. The circuit contains the shape memory alloy wire 15 that may be coupled through a mechanical switch 19 to an output port of a speech recognizer that is part of electronics 21. In this example, shape memory is represented as a resistor. Mechanical switch 19 may be an electronic switch in other embodiments. The speech recognizer may be a integrated circuit including a microcontroller or microprocessor used for speech recognition (e.g., the Sensory RSC4128 speech recognizer). An example of recognition techniques that may be used is disclosed in U.S. Pat. No. 5,790,754, titled “Speech Recognition Apparatus for Consumer Electronic Applications”, naming Forrest S. Mozer, Michael C. Mozer, Todd F. Mozer as inventors, the entire disclosure of which is incorporated herein by reference. An example of a recognizer that may be used is disclosed in copending U.S. patent application Ser. No. 10/938,346, titled “System and Method for Controlling the Operation of a Device by Voice Commands”, naming Todd F. Mozer, Forrest S. Mozer, and Erich B. Adams as inventors, the entire disclosure of which is incorporated herein by reference. The electronics 21 may also include a microphone, a speaker, and a battery. The speech recognizer may include software for implementing some or all of the speech recognition, for example.

The speech recognizer normally may operate in a powered-down mode that may be referred to as a low-power sleep mode. It may be awakened by claps, whistles, button pushing, etc., at which time it listens for a predetermined time period for the user's secret password spoken in the user's voice. The predetermined time period may be approximately three seconds in duration. If it recognizes the password in the user's voice during these three seconds, it generates voltage at the output and then powers down. The voltage may be generated for a predetermined time period that corresponds to the properties of the shape memory material used. According to the embodiment of FIG. 2A, this time period may be approximately one second in duration. This one second voltage heats the shape memory wire 15 to a temperature approximately above 70° centigrade in a fraction of a second. At this temperature, the shape memory wire 15 contracts to actuate a mechanical device (see FIG. 1A). For example, the contraction of shape memory 15 may pull the left portion of the part 9 away from the hook 7 in order to release the lid 3 and the mechanical switch 19 (see also FIG. 1B). Mechanical switch 19 may be opened by electronics 21 so that the output current is interrupted. This minimizes the load on the batteries and protects the shape memory wire 15 from overheating. The level and duration of the voltage may be adjusted according to the specific properties of the shape memory wire 15.

The speech recognizer in electronics 21 may also be awakened by pressing a pushbutton that may be included as part of the device. A higher level of security may then be achieved by requiring that this pushbutton be pressed in some coded way before the electronics 21 will come on and listen for the secret password. For example, the user can code the pushbutton such that the sequence of short push, long push, long push, short push is required to activate the remainder of the electronics 21. Or the coded pushbutton may be used as a backup means for opening the box in the event that the user forgets the password or is unable to speak in a recognizable way (e.g., if the user has a cold). Thus, the pushbutton code may have two functions, one to provide a higher level of security and the second to provide a backup. The codes in these two cases may be the same or different.

Controls for operating the speech recognizer may be located inside the box 1. As a backup system, the box 1 may be opened by pressing on the left side of the part 9 through a hole 17 in box 1 and hook 7 (see FIG. 1B). The hole 17 may be formed into an odd shape that corresponds to an odd-shaped key that is provided. When the box 1 is open, the user is able to set the security level of the password recognizer and the type of sound that is utilized to wake it up from its power down mode. At this time, the user may also change the password by training the recognizer on two repetitions of the new password or change the coded pattern of button presses required to activate recognition. The key provides a mechanical backup in the event that the batteries run down, the electronics malfunctions, or the user forgets the password.

The security level, password, password threshold, a backup override unlocking sequence, or other functions may be included in system software and accessed by a user through an input device, such as a push button system, for example. An example flow chart for button presses that activate the recognizer are as follows. For example, a user may press and hold a pushbutton and the system may automatically cycle through different states over time. The particular state the system is in may be communicated to a user by a display or an LED. For instance, software may be programmed to cause an LED to display the following colors corresponding to the state (or system mode) shown:

| | |
|---|---|
| flashing red light | nothing happens in this state if a user releases the |
| | button at this time. |
| solid red light | open sequence: enter push button 1 (PB1) code and |
| | password if released at this time. |
| solid green light | train password if released at this time. |
| solid red light | train PB2 code if released at this time. |
| solid amber light | Advance threshold if released at this time. |
| no light | Nothing happens if released at this time. |

During an initial time period, no input may be allowed. When the light turns red, a user may be required to first enter the proper push button sequence before the system will listen for the password. This provides additional security protection. Push button sequences may be short and/or long pulses, for example. If the proper preliminary push button sequence (PB1) is provided, the system will transition into a biometric input state that allows a user to enter a password, for example. If a user continues to hold down the button until the light turns green, a password training state may be entered, which allows a user to input a password by speaking a word, pushing a button, and then speaking the same password again, for example. The spoken word will then be the password of the system. If the LED turns back to red, the user may enter a pushbutton backup opening code (PB2). Accordingly, a code associated with the push button may be used as a back-up in case the user can't succeed with the biometric input or if the user simply forgot the password.

A flow chart for a system that uses a preliminary push button (PB1) and a backup pushbutton (PB2) is shown in FIG. 2B. While the following example illustrates operation of the system using a pushbutton, it is to be understood that other input devices may be used. At 201 the button is pressed. PB1 and PB2 may have default values (i.e., no button presses for PB1 and another code for PB2). If PB1 is set to require one or more button presses (i.e., PB1 is non-zero), then the system checks to see if the input was receive, and may check the sequence of inputs at 203. Some embodiments of the present invention may include a secret button, which when pressed will automatically open the lock (e.g., a key). If the secret button is included, the system may check to see if the button has been actuated at 205 (if PB1 is non-zero and not pushed). If the secret button is not pushed, the system may power down at 208. If the secret button is pushed the system may open the lock at 207.

If PB1 is no button presses (PB1 is set to zero at 202), the unit goes directly into recognition at 204. Recognition 204 may include one or more recognition steps. If the recognition is successful at 206, the system opens the lock at 207. If recognition fails, the unit may go into a backup mode and receive a second pushbutton sequence PB2, and the user can then open the lock by pressing the correct button sequence at 209. However, if PB2 is not set, the system may powerdown at 210. If PB2 is set, the system may detect the second input at 211. If the correct backup sequence is received, the lock is opened at 213. Thus, PB2 is a back-up in case of a recognition failure. Even if the backup fails, the lock may still be opened by accessing the secret button at 212. If the secret button is not pushed or is not available, the system may powerdown at 210.

Because the mechanical switch 19 provides information on the open/shut status of the device, the logic signal associated with the switch 19 may change the operation of the software depending on whether the device is open or shut. When it is shut, pressing the pushbutton with the correct coded pattern of short and long duration button presses places the electronics 21 in the mode to recognize a spoken password, or to open the box using a predefined sequence of button presses if a user forgets the password or if the password cannot be recognized. When it is open, pressing the pushbutton allows changing the operating parameters among a variety of operational states. For example, when the unit is open and the pushbutton is pressed for less than two seconds, nothing happens. When it is pressed for two to four seconds, a tri-color LED becomes red. If the user releases the pushbutton during this time, the threshold of sensitivity is increased by one level. If the user holds the pushbutton down for four to six seconds, the tri-color LED becomes green. If the user releases the pushbutton during this time, the unit prompts the user to speak his password twice, and this data is stored as the template against which the speech input is judged when the unit is closed. If the user holds the pushbutton down for six to eight seconds, the tri-color LED becomes yellow. If the user releases the button during this time, the unit accepts the sequence of short and/or long duration button presses that follow, and that sequence become the code that the user must apply when the unit is closed in order for speech recognition to become activated. If the user holds the pushbutton down for more than eight seconds, the LED turns off, and nothing happens when the button is released. This final state prevents the electronics 21 from consuming inordinate amounts of power when the button is stuck in the pressed state; for example, if the box is stowed and the button gets pushed accidentally. According to other embodiments, the time period and number of operational states may be adjusted according to design constraints or the specific features to be implemented.

For typical applications, the equal error rate of the password recognizer is about 6%, for example. This means that, while an intruder who does not know the password has a negligible probability of activating the lock mechanism by speaking random passwords, he has an approximately 6% probability of activation if he knows and speaks the correct password. The owner who trained the password has an approximately 6% probability of failing to open the lock when he says the password. These values may be adjusted for the desired level of security by controls that the user may adjust when the box is open, according to the specific features of the speech recognizer selected. According to another embodiment, an additional security feature is that, after two failed attempts to open the box by an intruder, it refuses to accept any more attempts for a given period of time. A further security feature can be that two passwords spoken in series are required, which decreases the probability that an intruder who knows the two passwords would gain entry to (0.06)² or about 0.0036.

The mechanical design of the part 9 and the shape memory wire 15 involves trade-offs that may be determined by iteration. To begin this iterative design, consider that the limiting current that can be provided by the circuit 21 of FIG. 2A may be 240 milliamperes according to one embodiment. For this current to heat the shape memory wire 15 to its contracting temperature of 70° centigrade in less than one second, the wire diameter must be less than or equal to approximately 0.004 inches. It is typically desired to use the largest diameter wire available because this maximizes the contraction force produced by the wire. For this reason, a 0.004 inch diameter wire is chosen. For long life, the wire should not be required to pull more than 25,000 psi. A 0.004 inch diameter wire has a cross-sectional area of 1.26×10⁻⁵ square inches, so it should be constrained to pull no more than 150 grams when it contracts. These values may be adjusted according to the specific properties of the shape memory wire 15 selected.

Besides speech recognition, other types of biometric information recognition may be performed according to design choice. Such other types of biometric information include a fingerprint, a face, a hand geometry configuration, an iris, a handwriting sample, and a skin configuration. The particular components of the biometric information recognizer in the electronics 21 will thus vary based upon the type of recognition to be performed.

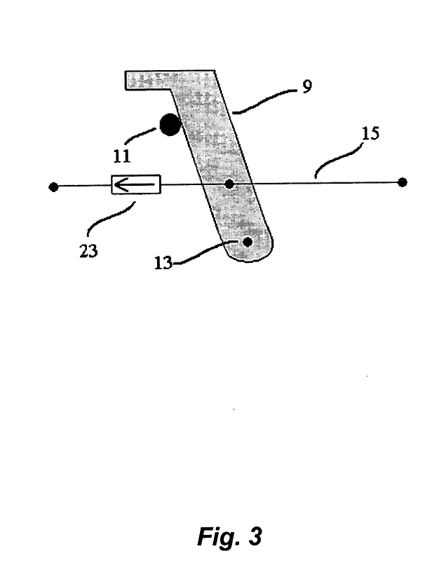

FIG. 3 is a simplified diagram of a locking mechanism that illustrates forces and displacements of a shape memory alloy wire and the locking mechanism, according to an embodiment of the present invention. FIG. 3 presents a drawing of the left portion of the part 9 that allows computation of forces and displacements of the shape memory wire 15. A spring 23 exerts a force in the direction of the arrow and represents the bending force of the left portion of the part 9. Just before the shape memory wire 15 is stretched such that the left portion of the part 9 hits the stop 11, the shape memory wire 15 experiences a stretching force of about 40 grams to stretch the wire 15 to its original length. Thus, the spring force of the spring 23 in the illustrated rest configuration should be about 40 grams. To contract, the shape memory wire 15 must pull this 40 gram load and overcome the frictional forces in the system. The main friction comes from sliding of the hook 7 over the left portion of the part 9. According to one embodiment, the coefficient of friction is approximately 0.5 and the vertical force on the hook 7, due to the force of the right portion of the part 9 on the lid 3, is approximately 10 grams. This frictional force of 5 grams at the hook 7 becomes about 12 grams at the location of the spring 23. Thus, the initial force required from the shape memory wire 15 is approximately 52 grams. At the end of the stroke, when the hook 7 is released, the effective force of the spring 23 is 90 grams, giving a total force at the end of the stroke of about 100 grams. This is safely below the capability of shape memory alloy wire 15 selected for use, so millions of operations are possible.

The total stroke required to free the hook 7 from the left portion of the part 9 is designed to be 0.075 inches. Because the part 9 rotates about the pivot 13, this stroke requires the shape memory wire 15 to compress by 0.030 inches. A 3% compression of the shape memory wire 15 keeps it well within a safe operating limit. Thus, a one inch length of shape memory wire 15 suffices for proper operation of the release mechanism. These parameters may be adjusted in other embodiments in accordance with the properties of the shape memory material selected for use.

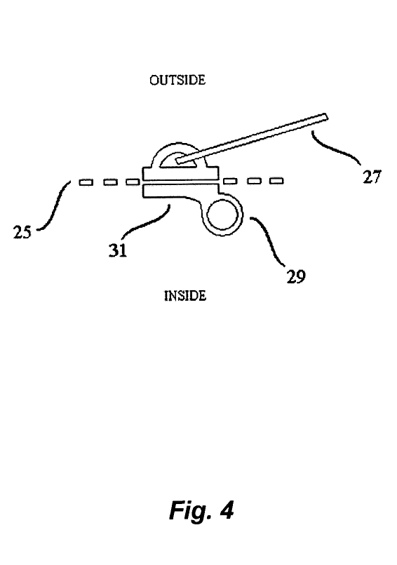

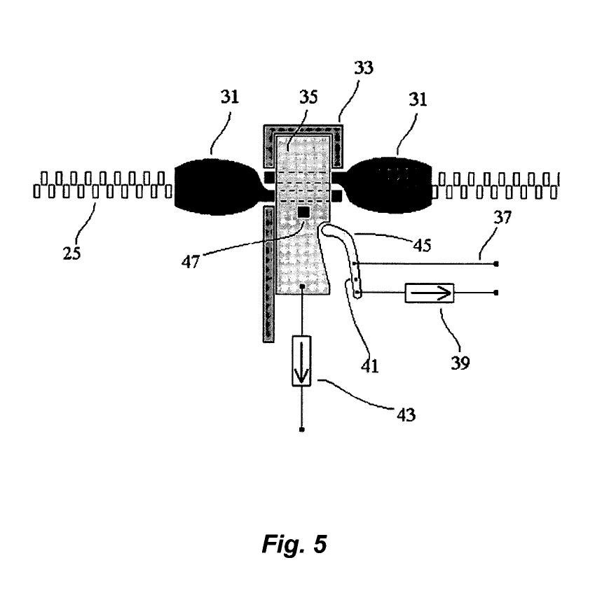

FIGS. 4-5 illustrate the design of a lock suitable for locking a suitcase or similar zipped-up product according to an embodiment of the present invention. FIG. 4 is a side view of one of two zipper bodies 31 that close together when the suitcase is fully zipped. The zipper bodies 31 ride on a zipper track 25 by being pulled by a zipper handle 27 to close the suitcase. When closed, two zipper eyelets 29 on the zipper bodies 31 come together, such that a lock piston placed through the zipper eyelets 29 prevents the suitcase from being opened.

FIG. 5 presents a cut-away view of the closed configuration (discussed above with reference to FIG. 4) that is rotated by 90° from the view of FIG. 4 and seen from the inside of the suitcase. The two zipper bodies 31 have been moved along the zipper track 25 such that the zipper eyelets 29 (see FIG. 4) are side-by-side. A lock piston 35 has been inserted through the zipper eyelets 29 into a position constrained by a lock housing 33, which keeps the two zipper bodies 31 locked together such that the suitcase is locked.

To unlock the suitcase, a part 45 may be rotated clockwise about a pivot point 41 to allow the lock piston 35 to slide downward under the force of a spring 43. This removes the lock piston 35 from between the zipper eyelets 29 (see FIG. 4) so that the zipper is free to open by pulling on the zipper handles 27 (see FIG. 4). The part 45 may be formed from plastic or other suitable material according to design preferences.

The lock piston 35 has two resting positions. One is the locked position of FIG. 5, and the other is the open position that is achieved when the part 45 is retracted by heating the shape memory wire 37. To lock the suitcase when the lock piston 35 is in the unlocked position, the user pushes a rod 47 vertically against the force of a spring 43 to elevate the lock piston 35 into the locked position. Because FIG. 5 is a view from inside the suitcase, the rod 47 may protrude through the mechanism in the opposite direction in order for the rod 47 to be available to the user.

As discussed above in connection with FIG. 1B, the forces of the springs 39 and 43 may be provided by deformation of larger parts 35 and 45. In such case, a simpler mechanism results that does not require actual springs. Such choice may be made according to design constraints or other considerations.

An intruder who tries to break the lock mechanism of FIG. 5 must pull the zipper handles 27 of the two zipper bodies 31 hard enough to break the lock piston 35. Such geometry allows at least two advantages. First, the locking mechanism associated with the shape memory wire 37 cannot be damaged by such attempts. Second, if the zipper eyelets 29 and the lock piston 35 are made from sufficiently strong materials, an intruder cannot break in by forcing the zipper in the manner described. Thus, this design provides the double security of an unbreakable lock and the requirement of password acceptance.

If the lock mechanism is part of a briefcase, for example, the entire briefcase can be stolen and opened remotely with a hammer and chisel. To prevent such theft, a chain with eyelets on its ends (similar to the zipper eyelets 29) can be provided. This chain can wrap around a large static object and its lock eyelets can be placed next to the zipper eyelets 29 (see FIG. 5) and locked to the briefcase through closure of the lock piston 35. In this way, the lock prevents both unauthorized entry of the briefcase and its theft.

In a similar way, a new type of padlock can be made. According to one embodiment, this padlock may be supplied with (for example) three chains, in which case a convenient name for this padlock is “The Chain Gang”. The chains may have different lengths from a few inches to a few feet, and they may have eyelets like the zipper eyelets 29 (see FIG. 4) on each end of the chains. Also provided is a module containing the electronics of FIG. 3 and the locking mechanism of FIG. 5. The operation of the padlock is as follows. A chain is selected for the locking task; the selected chain is wrapped around or through the object to be locked or tied down; the eyelets of the chain are fed into the position of the zipper lock eyelets 29 (see FIG. 5); and the lock piston 35 is closed to lock the chains into the module. In this way, something as small as a child's bank or as large as a bicycle may be locked shut or locked to any convenient stationary apparatus. This “Chain Gang” thus serves the role of an ordinary padlock plus a bicycle chain and it has the extra security associated with the biometrics.

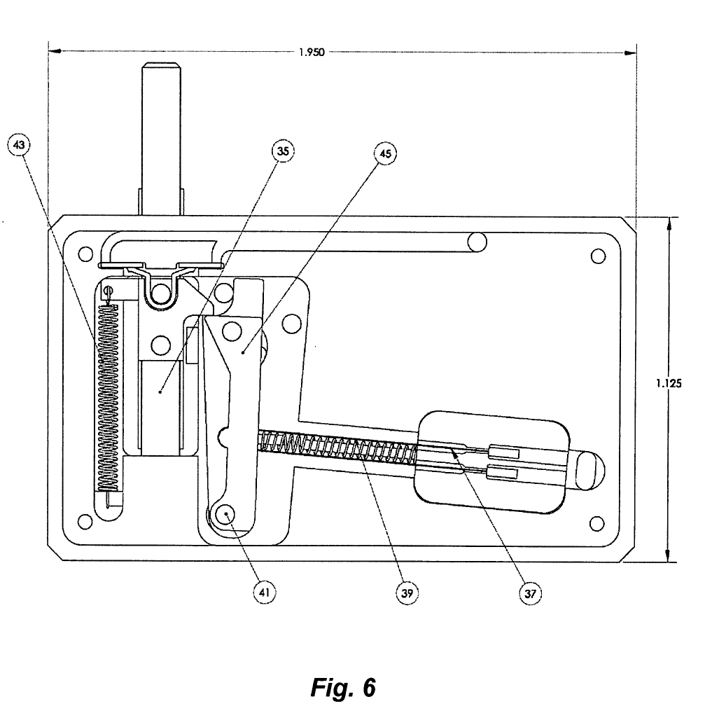

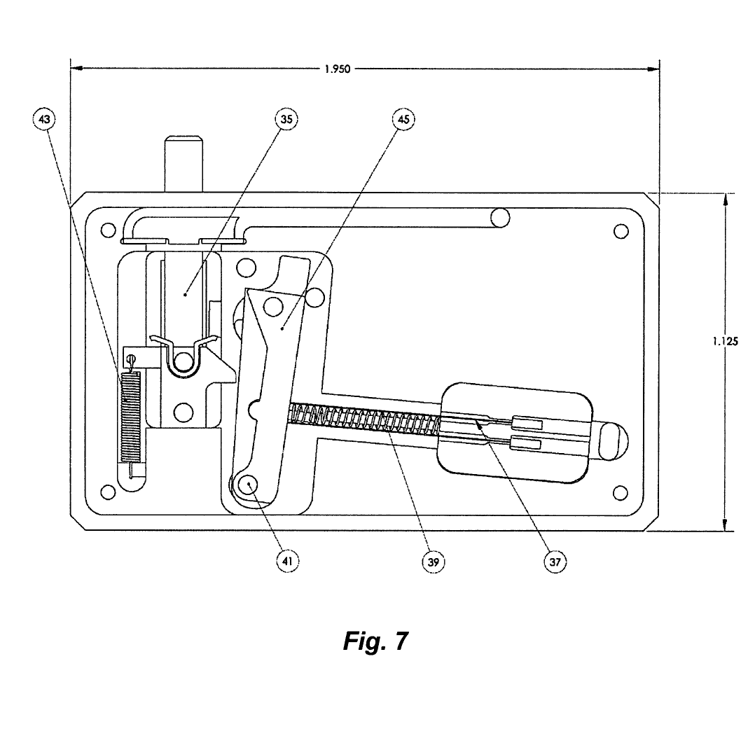

FIGS. 6-7 present engineering drawings of a locking mechanism based on the concepts described in FIGS. 4-5. In FIG. 6, the lock is closed because the lock piston 35 extends through the region in the upper part of the figure where the eyelets are inserted. In FIG. 7, the lock is open because the lock piston 35 has been retracted. This retraction is achieved by compressing the shape memory material 37 through applying the proper voltage across its terminals. When compressed, shape memory material 37 pulls against the spring 39. This rotates the hook 45 about the hinge point 41 to release the latching mechanism. This frees the lock piston 35, which is then pulled downward by the force exerted by the spring 43.

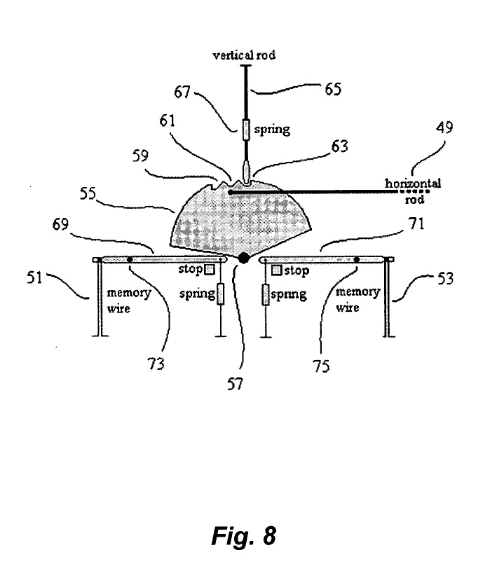

FIG. 8 illustrates another embodiment of the present invention that includes a shape memory material and biometric security. In FIG. 8, a horizontal rod 49 moves left or right when shape memory wires 51 and/or 53 contract after receipt of a correct biometric input. In FIG. 8, there are three positions of stable equilibrium of a pie-shaped piece 55 that rotates about a hinge 57. Each of the three positions (related to grooves 59, 61, and 63) is a stable equilibrium when no power is applied to the shape memory wires 51 and 53, because of the downward force on the bottom of a vertical rod 65 due to the force of a spring 67. The stable equilibrium that is pictured in FIG. 8 has the tip of the vertical rod 65 located in the groove 63. When the pie-shaped piece 55 is rotated clockwise such that the vertical rod 65 is in the groove 59, the horizontal rod 49 moves to the right. (According to one embodiment, the horizontal rod 49 moves to the right by 0.5 inches, which distance may vary according to design choice in other embodiments.) The left and/or right motion of the horizontal rod 49 may be used to control the position of an object such as the cover over a keyhole that may be used to unlock the device with a key, thereby providing double security.

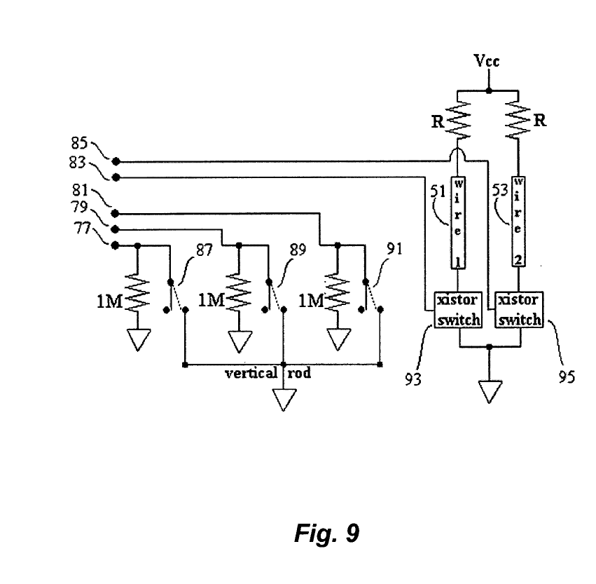

Rods 69 and 71 pivot around hinge points 73 and 75. Thus, when the shape memory wire 51 is heated and contracts, the shape memory wire 51 rotates the rod 69 counter-clockwise about the hinge point 73. This rotation causes the pie-shaped piece 55 to rotate clockwise and thereby to move the horizontal rod 49 to the right as the vertical rod 65 moves successively into the grooves 61 and 59. This activity is activated by receipt of an acceptable biometric signal such as speech, a fingerprint, an iris scan, etc. as is further described in FIG. 9.

FIG. 9 is a schematic of the operation of the electronics associated with the device of FIG. 8, according to an embodiment of the present invention. I/O pins 77, 79, 81, 83, and 85 of FIG. 9 come from the electronics that performs the evaluation of the biometric input. These pins serve as the interface to the mechanical apparatus of FIG. 8. The vertical rod 65 and the grooves 59, 61, and 63 (see FIG. 8) are conductive and are tied to opposite sides of switches 87, 89 and 91. When the vertical rod 65 is at the groove 63 in the pie-shaped piece 55 (see FIG. 8), the switch 91 of FIG. 9 is closed and the I/O pin 81 is low. In this way, by monitoring whether the I/O pins 77, 79, and 81 are high or low, the software knows the rotation angle of the pie-shaped piece 55. To rotate the pie-shaped piece 55 clockwise from its position in FIG. 8 upon receipt of a recognized biometric input, the memory wire 51 may be heated. This may be achieved by the software putting a logic low signal on the I/O pin 83 to close the switch 93, which causes current to flow through the shape memory wire 51. The contraction of the shape memory wire 51 pushes the pie-shaped piece 55 clockwise. Similarly, the pie-shaped piece 55 may be rotated counter-clockwise to move the horizontal rod 49 to the left when it is in the groove 59 (see FIG. 8) by putting a logic signal on the I/O pin 85. This signal closes the switch 95 to cause current to flow through the shape memory wire 53, which pushes the pie-shaped piece 55 counter-clockwise.

According to other embodiments of the present invention, the components of FIGS. 8-9 may be used to control the movement of other types of objects. According to one embodiment, the pie-shaped piece 55 may have more (or fewer) grooves that correspond to more (or fewer) positions of the horizontal rod 49. The horizontal rod 49 may be connected to a variety of objects in order to control their movement. According to one embodiment, the horizontal rod 49 controls facial features of a doll, such as opening and closing the eyes, or opening and closing the mouth. According to another embodiment, the horizontal rod 49 controls animation of an object such as a greeting card, such that a portion of the object moves as controlled by the movement of the horizontal rod 49. According to another embodiment, additional shaped memory wires may be included, for example, to move the pie-shaped piece 55 into additional positions.

As discussed above, the various embodiments of the present invention have a number of advantages as compared to many existing devices. Embodiments of the present invention disclose activating mechanical devices by the operation of shape memory materials in response to the human voice or other biometric information. Embodiments of the present invention decrease the cost and complexity of biometric controlled mechanical devices by the use of shape memory materials. Embodiments of the present invention reduce the noise produced by the operation of mechanical devices. Embodiments of the present invention reduce the size of mechanical controls by use of shape memory materials and biometric information. Embodiments of the present invention minimize the power drain in the operation of mechanical devices by use of shape memory materials with biometric information. Embodiments of the present invention disclose directly providing linear motion under command and control of the human voice or other biometric information.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. An apparatus for controlling a mechanical device, comprising:
a biometric information recognizer that processes a biometric input signal, and in accordance therewith, generates a recognition result;
a shape memory material coupled to said biometric information recognizer, wherein said biometric information recognizer triggers a current in said shape memory material if said recognition result indicates that said biometric input signal includes a predetermined criterion, and wherein said shape memory material changes shape in response to said current and reconfigures said mechanical device.

2. An electro-mechanical system comprising:
a biometric input device for receiving a biometric input from a user;
a biometric recognizer for recognizing the biometric input, the biometric recognizer generating recognition results;
a mechanical device; and
one or more shape memory elements coupled to the mechanical device and responsive to the recognition results.

3. A method of controlling a mechanical device, comprising:
receiving a biometric input signal;
processing said biometric input signal in a biometric information recognizer, and in accordance therewith, generating a recognition result;
generating a current in a shape memory material if said recognition result indicates that said biometric input signal includes a predetermined criterion, wherein said shape memory material changes shape in response to said current and reconfigures said mechanical device.
